(19) United States
(12) Patent Application Publication
(10) Pub. No.: US 2025/0041641 A1
(43) Pub. Date: Feb. 6, 2025

(54) FIRE EXTINGUISHING TANK EQUIPPED WITH FIXED FLOOR WATERING DEVICE FOR RESPONDING TO ELECTRIC VEHICLE CHARGING STATION FIRES

(71) Applicant: HANKOOK FIRE FIGHTING EQUIPMENTS CO.,LTD., Daegu (KR)

(72) Inventor: Soo Hwan CHEONG, Daegu (KR)

(73) Assignee: HANKOOK FIRE FIGHTING EQUIPMENTS CO.,LTD., Daegu (KR)

(21) Appl. No.: 18/385,654

(22) Filed: Oct. 31, 2023

(30) Foreign Application Priority Data
Aug. 2, 2023 (KR) 10-2023-0101242

(51) Int. Cl. A62C 3/07; A62C 37/38; A62C 37/46

(52) U.S. Cl. CPC A62C 3/07; A62C 37/38; A62C 37/46

(57) ABSTRACT

A fire extinguishing tank having a fixed floor watering device for responding to a fire of an electric vehicle charging station, includes a quadrilateral frame-shaped embedded groove formed on a bottom surface at a parking position of the electric vehicle charging station to surround an entering vehicle, and a tube storage part fixedly inserted into the embedded groove. The tube storage part has a storage body in which a receiving groove having a certain width and depth is formed, a gas injection type multi-wall tube having a central hole is accommodated in the storage body, an upper opening of the storage body is opened or closed by a cover, and, when a gas injection type multi-wall tube is inflated as air is injected therein, the opening/closing cover is automatically opened, and the inflated gas injection type multi-wall tube forms the tank to surround the vehicle from all sides.

### CROSS REFERENCE TO RELATED APPLICATION

This application claims priority to Korean Patent Application No. 10-2023-0101242 (filed on Aug. 2, 2023), which is hereby incorporated by reference in its entirety.

### BACKGROUND

The present disclosure relates to a fire extinguishing device and, more particularly, to a fire suppression tank for an electric vehicle charging station, which can detect and quickly extinguish a fire in the event of the fire occurring in an electric vehicle charging station.

Various large buildings or facilities are required to be equipped with various fire extinguishing facilities, such as fire hydrants, sprinklers, or watering systems, in accordance with the Fire Services Act and Building Act. However, a small space where the fire extinguishing facility is not required by law, especially a pit space containing electrical or communication facilities such as EPS or TPS is inevitably vulnerable to fire suppression in the event of a fire. Because of this problem, a separate automatic fire extinguishing device for the small space is installed in a position where there is a high risk of fire in the small space so as to prepare for fires.

In addition, as the spread of an electric vehicle increases recently, an electric vehicle charging station is essentially installed in an underground parking lot of a newly built apartment, and there is a trend for the electric vehicle charging station to be installed in a large parking lot of a government office or park.

However, fires often occur in the electric vehicle charging station. This may be caused by the abnormal operation of a battery or a charging device. In addition, this may be caused by an abnormal operation between the battery and the charging device. In particular, even if the fire caused by the vehicle battery is extinguished, there is a risk of re-ignition until the temperature of the battery is stabilized.

Generally, sprinklers are installed at regular intervals in the apartment underground parking lot. However, the sprinklers cannot trace an exact ignition point, thus making it impossible to early detect a fire. In particular, when the fire occurs in the electric vehicle charging station, it is difficult to quickly extinguish the fire using the sprinklers, and water that may be sprayed is limited, so continuous spraying is restricted.

The battery is located in a lower portion of the electric vehicle, and the main cause of the fire is the thermal runaway of the battery. In order to stabilize the battery, the temperature of the battery is lowered. Although spraying water from the lower portion is more effective, the typical sprinkler is located on a ceiling, so it is impossible to intensively spray water toward the point of fire and thereby the sprinkler has limitations in quickly extinguish the battery fire.

### Documents of Related Art

KR 10-2431474 “Fire suppression tank for electric vehicle charging station”

### SUMMARY

The present disclosure provides a fire suppression tank for an electric vehicle charging station, which detects a fire in the event of the fire while charging an electric vehicle and enables the fire to be quickly extinguished in an early stage.

In an aspect, the present disclosure provides a tank to quickly stabilize a battery in the event of a fire while charging an electric vehicle.

The tank includes a quadrilateral frame-shaped embedded groove formed on a bottom surface at a parking position of the electric vehicle charging station to surround an entering vehicle, and a tube storage part fixedly inserted into the embedded groove.

The tube storage part has a storage body in which a receiving groove having a certain width and depth is formed, a gas injection type multi-wall tube having a central hole is accommodated in the storage body, an upper opening of the storage body is opened or closed by an opening/closing cover, and, when a gas injection type multi-wall tube is inflated as air is injected therein, the opening/closing cover is automatically opened, and the inflated gas injection type multi-wall tube forms the tank to surround the vehicle from all sides.

A plurality of penetration holes are arranged on the bottom at the parking position, and each penetration hole is equipped with a spray nozzle that sprays fire-fighting water supplied through a fire-fighting conduit, so that, in the event of fire, the tank is filled with water, thus causing the battery of the electric vehicle to be submerged and thereby stabilized.

According to the present disclosure, a separate tank is provided at an electric vehicle charging position, so a control unit detects a fire in the event of the fire and immediately fills the tank with water, thereby causing a battery to be submerged and be quickly stabilized, and allowing the fire to be extinguished in an early stage.

### BRIEF DESCRIPTION OF THE DRAWINGS

FIG. 1 is a diagram illustrating the overall configuration of a fire suppression tank 2 for an electric vehicle charging station according to an embodiment of the present disclosure and a state in which the tank is formed.

FIGS. 2A and 2B are diagrams illustrating a configuration in which a tube storage part 10 forming the fire suppression tank 2 for the electric vehicle charging station is coupled to a parking position.

FIG. 3 is a diagram illustrating the configuration of the tube storage part 10 forming the fire suppression tank 2 for the electric vehicle charging station.

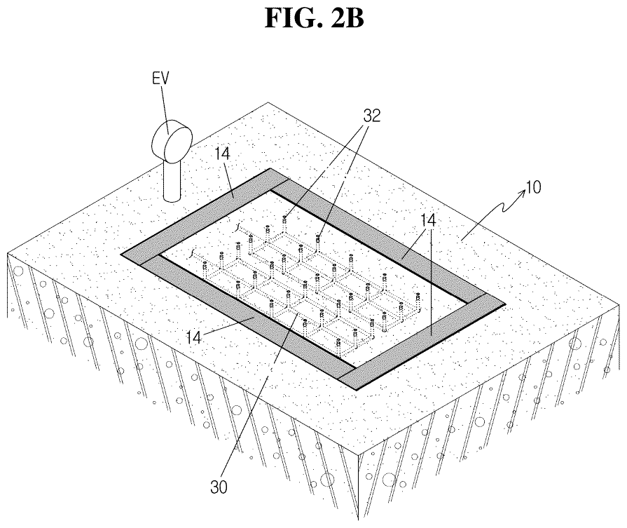

FIG. 4 is a sectional view illustrating main parts.

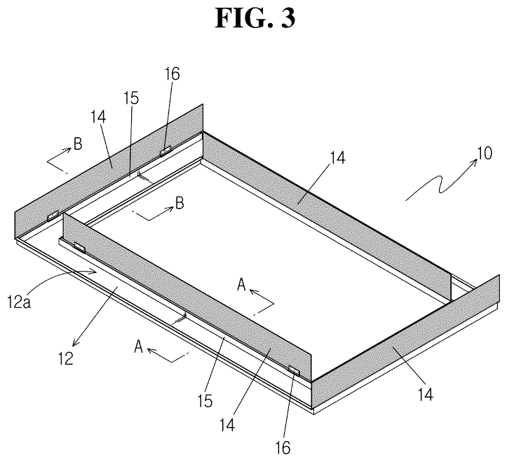

FIG. 5 is a diagram illustrating the configuration of a gas injection type multi-wall tube 20 forming the fire suppression tank 2 for the electric vehicle charging station.

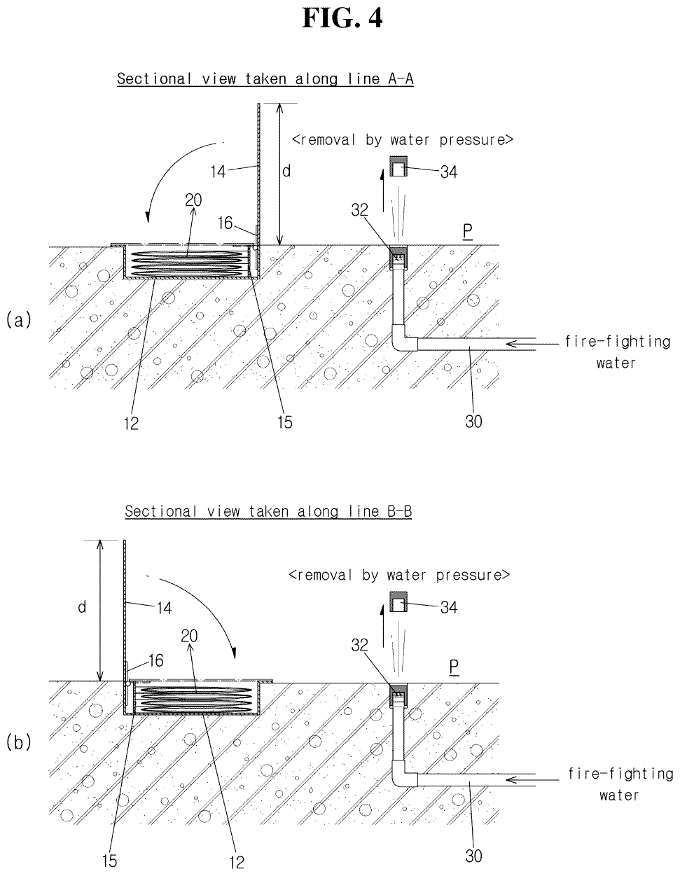

FIG. 6 is a diagram illustrating the position and configuration of a smoke detection sensor S2.

### DETAILED DESCRIPTION

Hereinafter, a preferred embodiment of the present disclosure will be described in detail with reference to the accompanying drawings.

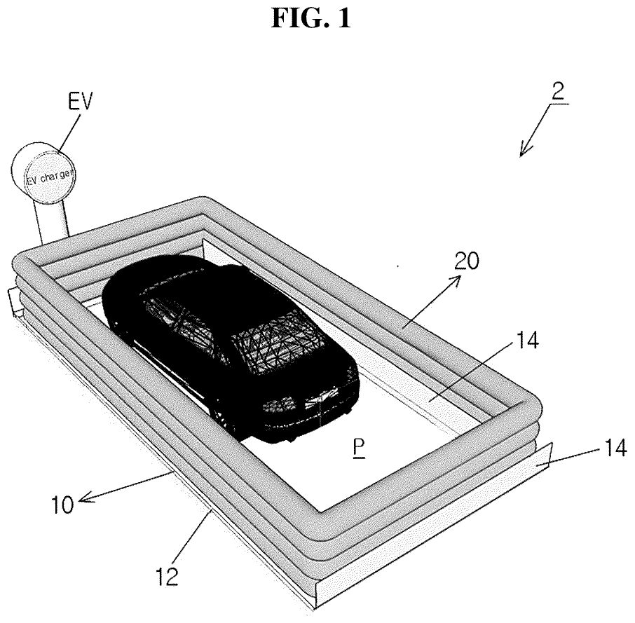

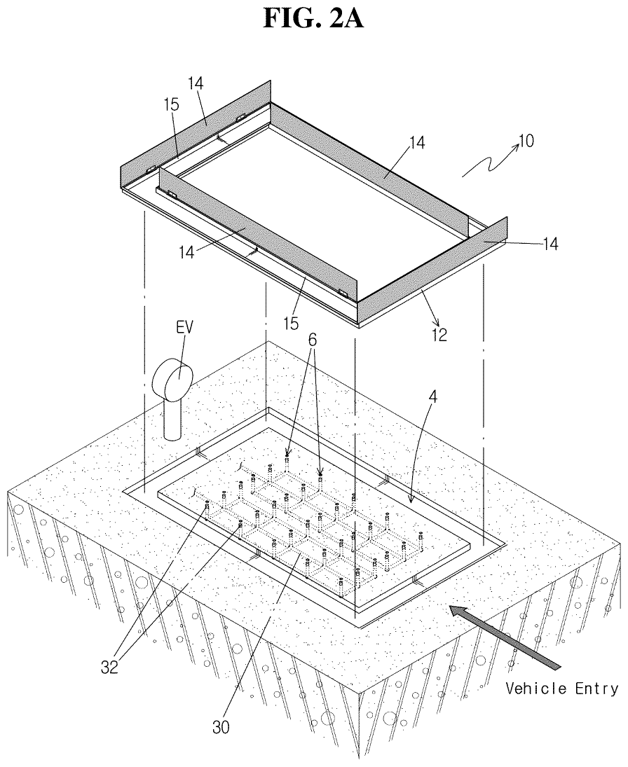

Referring to FIGS. 1, 2A and 2B, a fire suppression tank 2 is provided at a parking position for an electric vehicle charging station according to an embodiment of the present disclosure. That is, at a parking position P of the electric vehicle charging station, a quadrilateral frame-shaped embedded groove 4 is formed on a bottom surface to surround an entering vehicle, and a tube storage part 10 is fixedly inserted into the embedded groove 4.

The tube storage part 10 has a storage body 12 in which a receiving groove 12a having a certain width and depth is formed, and a gas injection type multi-wall tube 20 having a central hole 20a is accommodated in the storage body 12. The gas injection type multi-wall tube 20 is normally accommodated in the storage body 12 in a state where the air is released.

An upper opening of the storage body 12 may be opened or closed by an opening/closing cover 14, and is closed to protect the storage body in a state where the deflated gas injection type multi-wall tube 20 is accommodated therein. Further, when the gas injection type multi-wall tube 20 is inflated as air is injected therein, the opening/closing cover 14 is automatically opened, and the inflated gas injection type multi-wall tube 20 forms the tank to surround the vehicle from all sides.

A hinge 16 is coupled to the storage body 12 to allow the opening/closing cover 14 to be pivoted. The hinge 16 is located inside the receiving groove 12a to be stably operated even when it is embedded in the embedded groove 4.

The opening direction of the opening/closing covers 14 is as follows: when the opening/closing covers 14 located on the left and right sides of the parking position P are opened to the inside of the parking position P, the opening/closing covers 14 located on the front and rear sides are opened to the outside of the parking position P. In contrast, when the opening/closing covers 14 located on the left and right sides are opened to the outside of the parking position P, the opening/closing covers 14 located on the front and rear sides are opened to the inside of the parking position P, so interference between the covers is prevented during opening and closing operations. Here, it is preferable to prevent the opening/closing cover 14 from moving more than 90° by the hinge 16 during the opening operation.

A support 15 is coupled close to an inner side of the hinge 16 in the receiving groove 12a of the storage body 12, so that the opening/closing cover 14 is supported even when the load of the vehicle is applied thereto when the opening/closing cover 14 is closed. Further, a width d of the opening/closing cover 14 is larger than that of the receiving groove 12a, so an end opposite to the coupled portion of the hinge 16 is caught by the bottom surface when the opening/closing cover 14 is closed, and thereby the opening/closing cover is also supported even when the load of the vehicle is applied thereto.

The height of the gas injection type multi-wall tube 20 may be approximately 1 m, and this height allows the battery to be sufficiently submerged as water is filled. The lower end of the gas injection type multi-wall tube 20 is tightly coupled to the inner bottom surface of the storage body 12 to make it waterproof.

The reason why the multi-wall tube 20 is formed in the present disclosure is as follows: when water is sprayed with an existing watering device, a huge amount of water is needed to continue spraying water until the temperature of the battery is lowered. In contrast, when the tank is constructed using the gas injection type multi-wall tube 20, the battery may be submerged and stabilized with a small amount of water. Such a tank prevents, to some extent, fire from being transferred to a vehicle next to the vehicle in the event of fire.

The gas injection type multi-wall tube 20 is normally folded with the air being released, and then is inflated as the air is injected, thus forming a wall to surround the electric vehicle. In order to inject the air into the gas injection type multi-wall tube 20, one or more separate air inlets may be provided. The air inlet may be connected though a hose to a cylinder or compressor filled with compressed air to automatically inject the air in the event of fire. Preferably, it is economical and easy to connect the air inlet to the cylinder, and the cylinder is equipped with a solenoid valve to automatically open the valve when the fire is detected. The gas injection type multi-wall tube 20 is formed by vertically stacking a plurality of individual unit tubes 21 and coupling the tubes with each other.

In the present disclosure, as mentioned in the background section, the battery is located in the lower portion of the electric vehicle, and the main cause of the fire is the thermal runaway of the battery. In order to stabilize the battery, the temperature of the battery is lowered. Considering that spraying from the lower portion is more effective, the position of the spray nozzle is differentiated. Further, in order to allow the fire suppression tank 2 to be filled with water within a short time and then cause the vehicle battery to be submerged in the event of fire, a fixed floor watering device is installed on a bottom at a position where a separate electric vehicle enters.

That is, according to the present disclosure, a plurality of penetration holes 6 are arranged on the bottom at the parking position P, and each penetration hole 6 is equipped with a spray nozzle 32 that sprays fire-fighting water supplied through a fire-fighting conduit 30. Thus, in the event of fire, water is sprayed from the bottom to the top to fill the tank with water, thus causing the battery of the electric vehicle to be submerged and thereby stabilized. The spray nozzle 32 may be configured as a sprinkler. Further, a plug 34 is inserted into the penetration hole 6 to protect the spray nozzle 32 and prevent foreign substances from entering the penetration hole 6. In the event of fire, as the fire-fighting water is sprayed from the spray nozzle 32, the plug is removed by water pressure.

The spray nozzle 32 is embedded approximately 20 mm below the ground, and the height of the plug 34 is set to match the bottom surface as much as possible or be located slightly under the bottom surface. Meanwhile, the plug 34 may be inserted into the penetration hole 6, and then the plug may be removed as the spray nozzle 32 moves up in the event of fire.

In the present disclosure, two types of detectors may be used to detect the battery fire. One type is a thermal imaging sensor (heat detection sensor) and the other type is a smoke detection sensor.

The thermal imaging sensor S1 is located at the bottom, that is, between the spray nozzles 32. Here, it is preferable to perform water-proof housing treatment so as to prevent mechanical failure from occurring even if a water level rises when the spray nozzle 32 is sprayed.

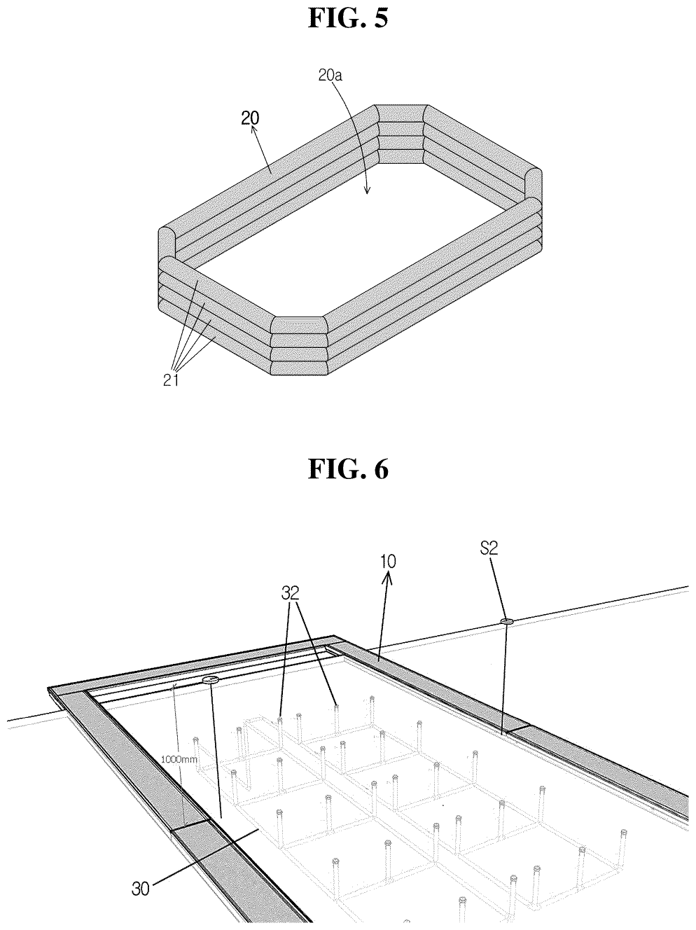

As shown in FIG. 6, the smoke detection sensor S2 is preferably located at a height of about 1 m above a bottom surface, and may be installed on the left or right side of the parking position. Smoke is lighter than air and is diffused upward, and there is a high probability that smoke will be trapped inside a battery pack or inside the vehicle in the event of the battery fire. Thus, if the sensor is located higher than 1 m or on a ceiling, there is a problem that it takes a long time to detect a fire even if the fire occurs. The smoke detector may be placed on a side of the parking position P in the entry/exit direction.

In general, the heat detection in the control unit is first performed by the thermal imaging sensor S1 and then by the smoke detection sensor S2.

Although a preferred embodiment of the present disclosure has been described for illustrative purposes, those skilled in the art will appreciate that various modification, additions and substitutions are possible, without depart from the scope and spirit of the invention as disclosed in the accompanying claims.

What is claimed is:

1. A fire extinguishing tank having a fixed floor watering device for responding to a fire of an electric vehicle charging station, the tank comprising:
a quadrilateral frame-shaped embedded groove formed on a bottom surface at a parking position of the electric vehicle charging station to surround an entering vehicle, and a tube storage part fixedly inserted into the embedded groove,
wherein the tube storage part has a storage body in which a receiving groove having a certain width and depth is formed, a gas injection type multi-wall tube having a central hole is accommodated in the storage body, an upper opening of the storage body is opened or closed by an opening/closing cover, and, when a gas injection type multi-wall tube is inflated as air is injected therein, the opening/closing cover is automatically opened, and the inflated gas injection type multi-wall tube forms the tank to surround the vehicle from all sides,
wherein a plurality of penetration holes are arranged on the bottom at the parking position, and each penetration hole is equipped with a spray nozzle that sprays fire-fighting water supplied through a fire-fighting conduit, so that, in the event of fire, the tank is filled with water, thus causing the battery of the electric vehicle to be submerged and thereby stabilized.

2. The fire extinguishing tank of claim 1, wherein a hinge is coupled to the storage body to allow the opening/closing cover to be pivoted, and the hinge is located inside the receiving groove to be stably operated even when it is embedded in the embedded groove,
a support is coupled close to an inner side of the hinge in the receiving groove of the storage body, so that the opening/closing cover is supported even when the load of the vehicle is applied when the opening/closing cover is closed, and
a width of the opening/closing cover is larger than that of the receiving groove, so that an end opposite to a coupled portion of the hinge is caught by the bottom surface when the opening/closing cover is closed, and thereby the opening/closing cover is also supported even when the load of the vehicle is applied.

3. The fire extinguishing tank of claim 1, wherein a plug is inserted into the penetration hole to protect the spray nozzle and prevent foreign substances from entering the penetration hole, and, as fire-fighting water is sprayed from the spray nozzle, the plug is removed by water pressure.
